(19) United States
(12) Patent Application Publication
(10) Pub. No.: US 2020/0147628 A1
(43) Pub. Date: May 14, 2020

(54) SPLASH SHIELD FOR A WALL MOUNTED TAP

(71) Applicant: Jamie BANKS, Brahma Lodge (AU)

(72) Inventor: Jamie BANKS, Brahma Lodge (AU)

(21) Appl. No.: 16/684,017

(22) Filed: Nov. 14, 2019

(30) Foreign Application Priority Data
Nov. 14, 2018 (AU) 2018101692

(51) Int. Cl. B05B 12/32

(52) U.S. Cl. CPC B05B 12/32

(57) ABSTRACT

A shield adapted for attachment to a wall mounted tap in order to form a protective barrier and prevent splash against the wall when the tap is in use.

### FIELD OF THE INVENTION

The present invention relates to a splash shield to cover and protect a wall when a tap is in use.

### BACKGROUND TO THE INVENTION

Inside the home, office, or indoor worksite it is common for a wet area such as a bathroom, laundry, or kitchen to have some kind of water resistant protection. Often this takes the form of a “splash back”, being a protective coating of tiles, acrylic, or glass over the wall behind a tap in order to prevent water splash or other splatter onto the wall.

However exterior walls of a building containing outdoor water taps do not have such protection, and as a consequence the wall is often splashed with water or other liquids from use of the taps, for example if someone were to wash dirt off their hands after gardening, or paint off their hands after painting, the consequent splash back may cause the wall to become stained or unsightly. It is also possible for the water to drip down the face of the wall and into the lower foundations, and over the long term cause salt damp or other structural damage.

The object of this invention is to provide a splash shield that alleviates the above problems, or at least provides the public with a useful alternative.

### SUMMARY OF THE INVENTION

In a first aspect the invention comprises a shield for a wall mounted tap comprising a sheet of waterproof material with an aperture, and wherein the tap is inserted through the aperture and the shield provides a barrier between the wall and the tap;

In preference, the shield is oblong shaped with straight horizontal sides and curved vertical sides, and wherein the upper horizontal side is of a shorter length than the lower horizontal side, and the curved vertical sides are of equal length.

In preference, the aperture is teardrop shaped;

In preference, the shield is made from corflute; and

In preference, the sheet is a flexible plastic allowing the shield to be rolled up for easy transport and storage.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 is a front view of a splash shield for an outside tap;

FIG. 2 is a side view of a splash shield attached to an outside tap; and

FIG. 3 is a front view of a splash shield attached to an outside tap.

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

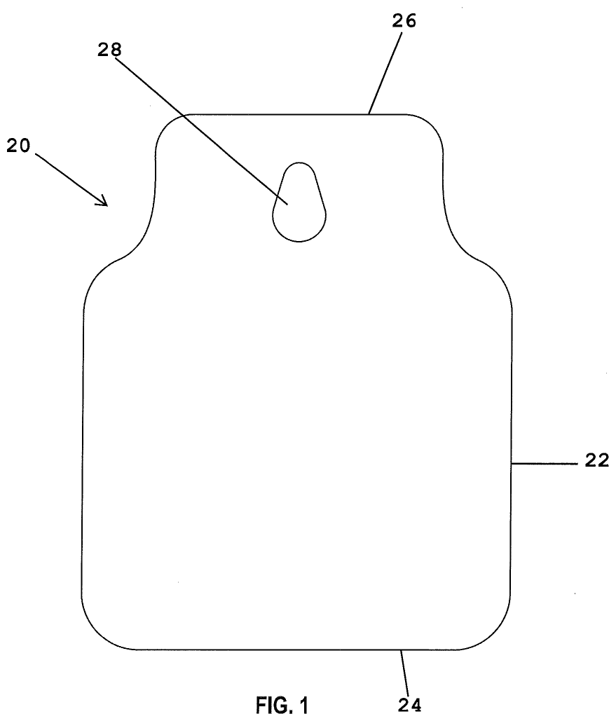

Turning now to the drawings there is illustrated in FIG. 1 a splash shield 20 formed from a single sheet of protective, waterproof material. In a first embodiment of the invention the material is corflute or another semi-rigid plastic, allowing the sheet to maintain its shape even when wet. In a second embodiment of the invention the material is of a flexible plastic such a low density polyethylene, allowing the sheet to be folded or rolled allowing for easy transport and storage. In this second embodiment, the sheet can be fixed to the wall using various means, for example a weight to keep the sheet unrolled when in use, or an adhesive allowing the sheet to be fixed to the wall.

The shield 20 is of a basic oblong shape with curved vertical sides 22 and straight horizontal sides 24 and 26, and wherein the upper horizontal side 26 is of a shorter length than the lower horizontal side 24 and the curved vertical sides 22 are of equal length. The shield 20 contains a teardrop-shaped aperture 28 below the upper horizontal side 26 and in line with the respective curves of the vertical sides 22.

In preference, the measurements are 550 mm for the lower horizontal side 24, 250 mm for the upper horizontal side 26, 750 mm total for the vertical sides 22, wherein the measurement of the curve is 90 mm. However it is to be understood that the invention includes various other measurements and shapes which serve the same purpose.

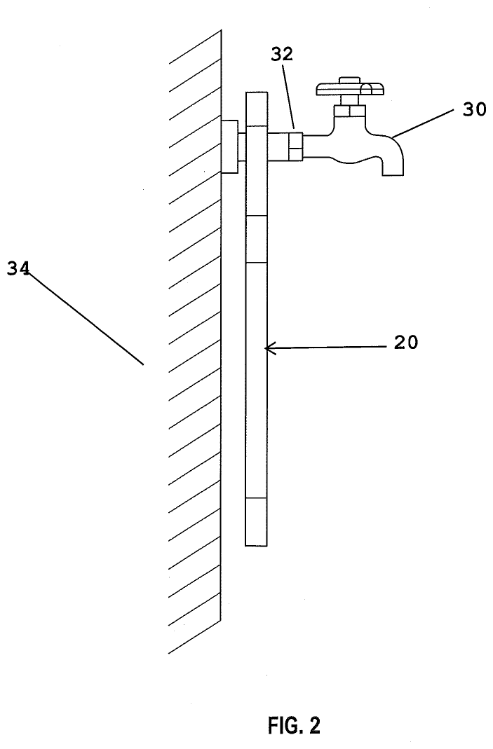

The user will attach the shield by inserting the tap 30 through the aperture 28 and allowing the shield 20 to hang or rest on the pipe 32 jutting out from the wall 34 as illustrated in FIG. 2. The curved shape of the upper portion of the shield allows for easy application and removal.

The shield 20 therefore rests either parallel to the wall or flush against the wall, forming a barrier or protective layer. Accordingly, when the tap 30 is switched on and water is released, any splash created will impact against the shield 20 and not the wall which will remain dry and unsoiled.

The user can then remove the shield 20 when they are finished using the tap, and clean off any water or other markings from the shield.

For example, the user may be attending to some painting and as a consequence gets paint on their hands. Without the present invention when they washed their hands using water from the tap, the paint is removed from the user's hands and may splash onto the wall behind the tap. The wall would then need to be cleaned which may be difficult or create smudging, or alternatively the pain will then dry on the wall causing an unsightly stain.

However if the user put the shield 20 into place before washing their hands, any water and paint will splash onto the shield keep the wall dry and unstained. It will also ensure that any water runoff will be from the shield and not run down the wall and into the building foundations.

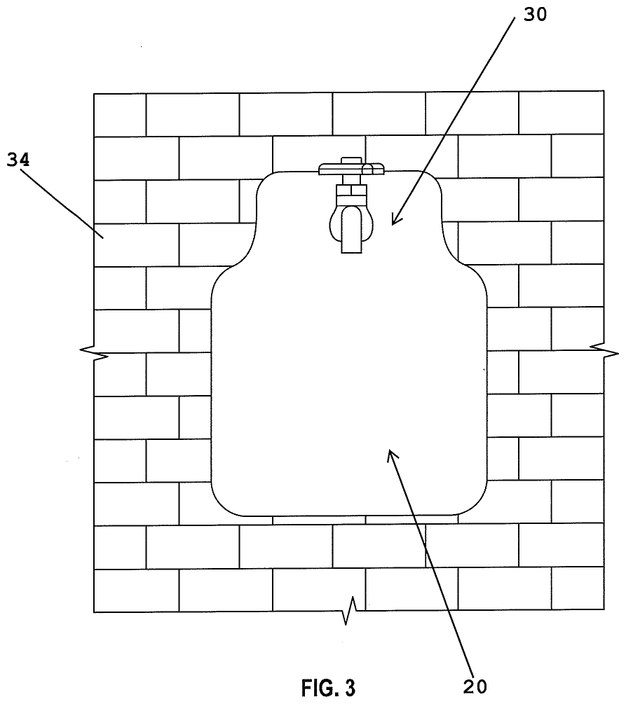

Illustrated in FIG. 3 is a view of the shield 20 attached to the tap 30, providing broad coverage across the wall and the area around the tap. It is to be understood that the shield can be of varying size, and in an alternate embodiment cover the entire length of the wall from the tap down to the base of the wall providing further coverage and protection.

It is also to be understood that while the invention is primarily directed for use with the outdoor taps, it can be adapted for use with any wall mounted tap whether in a domestic or commercial environment.

The reader will now appreciate the present invention which is a shield for a wall to prevent splash from a tap and consequent water damage or staining.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A temporary shield for a wall mounted tap extending horizontally from the wall and comprising a sheet of material with an aperture, and wherein the tap is inserted through the aperture and the shield abuts the wall and the shield provides a barrier between the wall and the tap.

2. The temporary shield according to claim 1 wherein the shield is oblong shaped with straight horizontal sides and curved vertical sides, and wherein the upper horizontal side is of a shorter length than the lower horizontal side, and the curved vertical sides are of equal length.

3. The temporary shield according to claim 1, wherein the aperture is teardrop shaped.

4. The temporary shield according to claim 1, wherein the sheet is semi-rigid material.

5. The temporary shield according to claim 1, wherein the sheet is made from a flexible plastic allowing the shield to be rolled up for easy transport and storage.

6. A method of shielding a wall surrounding a mounted tap, said method comprising:
providing a tap that is mounted on a pipe extending horizontally from a wall of a building;
providing a shield of material;
defining an aperture in the shield; wherein the aperture extends from a front surface of the shield to a rear surface of the shield;
positioning the shield such that the rear surface thereof faces the wall;
inserting the tap and a portion of the pipe through the aperture of the shield;
moving the shield toward the wall such that the rear surface thereof is located proximate the wall;
hanging the shield from the portion of the pipe;
protecting the wall with the shield when the tap is in use; and
removing the shield from the tap and pipe once the tap is no longer being used.

7. The method according to claim 6, wherein the providing of the tap includes providing the tap on an exterior wall of a building such that the tap is located outside the building.

8. The method according to claim 6, wherein the defining of the aperture comprises defining a teardrop-shaped aperture in the shield of material.

9. The method according to claim 6, wherein the providing of the shield includes fabricating the shield from a semi-rigid material.

10. The method according to claim 6, wherein the providing of the shield includes fabricating the shield from a flexible plastic material; and the method further includes rolling the shield up after removal of the shield from the tap and pipe.
